(19) United States
(12) Patent Application Publication
(10) Pub. No.: US 2007/0178218 A1
(43) Pub. Date: Aug. 2, 2007

(54) Legume Products, Compositions Including the Legume Products and Methods of Distributing the Legume Products

(76) Inventors: Brian Yager, Decatur, IL (US); Eric White, Decatur, IL (US)

Correspondence Address: ARCHER DANIELS MIDLAND COMPANY, 4666 FARIES PARKWAY, DECATUR, IL, 62526, US

(21) Appl. No.: 11/670,733

(22) Filed: Feb. 2, 2007

Related U.S. Application Data
(60) Provisional application No. 60/764,459, filed on Feb. 2, 2006.

(51) Int. Cl. A23L 1/20

(52) U.S. Cl. 426/634

(57) ABSTRACT

Food products containing legume products, as well as processes for producing and distributing the legume containing food products are disclosed.

### CROSS-REFERENCE TO RELATED APPLICATIONS

This application claims the benefit of U.S. Provisional Application No. 60/764,459, filed Feb. 2, 2006, the contents of the entirety which is incorporated by this reference.

### TECHNICAL FIELD

The present invention relates generally to food technology, and more particularly, to food products containing legume products.

### BACKGROUND

In the United States, there is increasing concern over the consumption of high sugar and high fat foods by the population. In fact, in 2005, the US government revised the Dietary Guidelines for food consumption in the United States. One of the goals of the revision of the Dietary Guidelines was to stop the alarming increase in obesity among the citizens in the United States, since many people in the United States are overweight due to a lack of exercise and poor eating habits.

In the 2005 Dietary Guidelines Pyramid, beans and peas are listed under both the Vegetables and the Meats and Beans categories, thus, emphasizing the healthy nature of legumes in the diet. In addition to the emphasis on lower fat and lower sugar diets, beneficial effects of legumes are becoming apparent. For instance, inositol polyphosphates, which are naturally occurring substances found in most legumes, have been implicated in being able to inhibit the growth of some cancer xenografts. (See, Cancer Resources, 2005; 65: (18), Sep. 15, 2005). Thus, the health benefits of legumes have gaining recognition.

With the increased awareness of the problems of obesity in the US and the increased awareness of the health benefits of legumes, there exists a need for healthier food products and foodstuffs that provide the beneficial nutritional effects of legumes.

### SUMMARY OF THE INVENTION

In each of its various embodiments, the present invention helps fulfill these needs and discloses healthier food products and processes for producing them.

In one embodiment, a composition comprises a legume ingredient selected from the group consisting of a substantially intact dehydrated legume, a dehydrated legume product, and a combination thereof. A specified amount of the legume ingredient has a higher dietary fiber content as compared to the same, specified amount of a legume from which the legume ingredient originates on a dry weight basis.

In another embodiment, a composition configured as a food dip includes whole beans having an increased dietary fiber content as compared to an equal amount of a bean from which the whole beans originate on a dry weight basis, and at least one of a fruit product, a vegetable product and combinations thereof.

In a further embodiment, a composition configured as a sauce comprises a bean product having an increased dietary fiber content as compared to an equal amount of a bean from which the bean product originates on a dry weight basis and an edible fat or oil. The composition further includes a thickening agent and an emulsifier.

In yet a further embodiment, a composition configured as a salsa includes at least one bean product having an increased dietary fiber content as compared to an equal amount of a bean from which the bean product originates on a dry weight basis, and an edible fat or oil. The salsa composition further includes a thickening agent, an emulsifier, and at least one of a fruit product, a vegetable product and combinations thereof.

In yet an additional embodiment, a composition configured as a food dip includes a bean product having an increased dietary fiber content as compared to an equal amount of a bean from which the bean product originates on a dry weight basis. The composition may further include a thickening agent.

In another embodiment, a composition configured as hummus comprises whole beans having an increased dietary fiber content as compared to an equal amount of beans from which the whole beans originate on a dry weight basis. The composition also includes at least one of a fruit product, a vegetable product, and combinations thereof, and an edible fat or oil.

In one embodiment, a composition configured as a baked bean mix includes whole beans having an increased dietary fiber content as compared to an equal amount of a bean from which the whole beans originate on a dry weight basis, at least one seasoning, and at least one of a fruit product, a vegetable product, and combinations thereof.

In yet a further embodiment, a composition configured as a soup comprises whole beans having an increased dietary fiber content as compared to an equal amount of a bean from which the whole beans originate on a dry weight basis, at least one of a fruit product, a vegetable product, and combinations thereof, and a soy protein source.

In yet an additional embodiment, a composition comprises a legume ingredient having an increased dietary fiber content as compared to a legume from which the legume ingredient originates on a dry weight basis, the legume ingredient being selected from the group consisting of a substantially intact dehydrated legume, a dehydrated legume grit, a dehydrated legume powder and a combination of any thereof. The composition further includes a compound selected from the group consisting of a diacylglycerol oil, xanthan gum, whole soybean powder, a soluble fiber, an emulsifier, a protein enriched pasta, a protein enriched dry mix, and combinations of any thereof. The composition also includes water present in an amount such that the composition has the characteristics of a foodstuff selected from the group consisting of a dip, a sauce, a chutney, hummus, a dressing, a baked bean mix, a soup, a jam, a jelly, a salsa, a picante, an enchilada sauce, a taco sauce, a burrito sauce, a marinade, a condiment, a stew, a chowder, a pasta sauce and a tomato based sauce. The composition has at least two grams of dietary fiber per thirty grams of the composition.

Methods of distributing the compositions of the present invention are also described, as well as methods of increasing the fiber and/or protein consumption in a population by distributing the compositions of the present invention to the population.

### BEST MODE OF THE INVENTION

Food products containing legume products, as well as processes for producing and distributing the food products are disclosed. Food compositions having legumes or legume products are typically high in fiber and/or protein as compared to the foodstuff not including the legume or legume product. Thus, the incorporation of legumes or legume products into a foodstuff results in a foodstuff having a higher content of fiber and/or protein, while reducing the sugar and/or fat content of the foodstuff.

In one embodiment, a food product or ingredient used in a foodstuff comprises a legume product. The presence of the legume product in the foodstuff enhances or increases the amount of fiber and/or protein in the foodstuff, thus, helping a person consuming the foodstuff to meet their Dietary Guidelines for fiber and/or protein intake. In another embodiment, distribution of the foodstuff having the enhanced or increased fiber and/or protein to a population may help increase the nutrition of the population and, potentially, help lower incidences of obesity or other diet related diseases.

In one embodiment, the legume from which the legume product originates may be of a Phaseolus species (i.e., beans). In other embodiments, the legume may comprise green or yellow peas (i.e., Pisum), lentils (i.e., Lens vulgaris), chickpeas (i.e., Cicera arietenum), soybeans (i.e., Glycine max), peanuts, (i.e., Arachis hypogaea), trefoil (i.e., Lotus corniculatus), and combinations of any thereof. In further embodiments, varieties of beans that may be used to produce the foodstuffs of the present invention include, without limitation, Pinto beans, Great Northern beans, Navy beans, Red beans, Black beans, dark or light Red Kidney beans, Fava beans, Green Baby Lima beans, Pink beans, MYASI beans, Mayocoba beans, Small Red beans, Black Eyed beans, Garbanzo beans, Cranberry beans, White Beans, Rice beans, Butter beans, African Giraffe beans and any combination thereof.

In various embodiments, a food product or ingredient of the present invention may take various forms including, but not limited to, a dip, a sauce, a dressing, a burrito sauce, a jam, a jelly, a chutney, a salsa, a picante, an enchilada sauce, a taco sauce, a marinade, a condiment, a soup, a stew, a chowder, a pasta sauce, a tomato based sauce, or a combination of any thereof. Further, the food product or ingredient may be incorporated into a foodstuff in combination with one or more seasonings, spices, a prepared food product, a meat, a meat analogue, or any combination thereof in order to enhance the flavor or nutrition of the foodstuff. In yet other embodiments, processing aids or preservatives may be added to the food product or ingredient in order to affect functionality and shelf life of the foodstuff.

In one embodiment, the legume ingredient may comprise at least 3% of the weight of the food composition of the present invention. In other embodiments, the legume ingredient may comprise at least 8%, at least 15%, at least 20%, at least 42% or at least 55% of the weight of the composition.

In yet additional embodiments, other ingredients such as food colorants, vitamins, minerals, edible oils or fats, emulsifiers (i.e., lecithin or a monoglyceride), leavening agents, natural or artificial sweeteners, starches, thickening agents including without limitation a starch or gum (i.e., a xanthan gum), a digestion resistant starch, fiber (including, but not limited to, a soluble fiber or an insoluble fiber), a cellulose (i.e., microcrystalline cellulose or carboxymethylcellulose), maltodextrins, corn-syrup solids, potato starch, corn starch, wheat starch, a vegetable product, a fruit product, a nut product, a sterol, a lignan, an isoflavone, a canola protein concentrate, a canola protein isolate, an organic acid, water, a soy isolate, a soy concentrate, wheat protein isolate, a sugar alcohol, a calcium containing compound (i.e., calcium citrate, calcium lactate or calcium carbonate), a tomato product, or combinations of any thereof may be used.

Examples of soluble fibers that may be used include, but are not limited to, pyrodextrins or insoluble maltodextrins available under the brand name FIBERSOL® (available from Archer Daniels Midland Company Decatur, Ill.; FIBERSOL® is a registered trademark of Matsutani Chemical Industry Co. Ltd.) or NUTRIOSE SOLUBLE FIBER™ (available from Roquette Freres, Cedex, France). Other soluble fibers include, without limitation, fructans or fructose oligosaccharides (OLIGGO-FIBER® brand inulin and/or oligofructose (available from Cargill Health & Food Technologies, Minneapolis, Minn.). Any food grade emulsifier may be used. Food-grade emulsifiers are amphiphilic lipids manufactured from edible fats and oils or fatty acids esterified with polyvalent alcohols together with food acids. Non-limiting examples of such emulsifiers include, but are not limited to acetic acid esters, citric acid esters, diacetyl tartaric acid esters of monoglycerides, distilled monoglycerides, emulsifier blends, lactic acid esters, tartaric acid esters, lecithin, lecithin blends, monoglycerides, diglycerides, polyglycerol esters, polyglycerol polyricinoleates, sorbitan esters, sorbitan monostearate, ethoxylated monoglycerides, sodium stearoyl lactylates, propylene glycol monostearate, sucrose esters, fatty acid esters of sugar alcohols, calcium stearoyl lactylates, polysorbates, and combinations of any thereof.

Examples of edible oils that may be used include, but are not limited to, a low trans-fat shortening such as, for example, NovaLipid brand 106-150 shortening available from Archer Daniels Midland Company of Decatur, Ill., which is an interesterified oil having zero grams of trans-fat per serving and wherein about 90% of the saturated fat of the NovaLipid brand 106-150 shortening is stearic acid. In another embodiment, the oil or fat may be any type of edible oil including, but not limited to, sunflower oil (e.g., a mid-oleic sunflower oil), canola oil, soy oil, peanut oil, cotton seed oil, palm oil, a diacylglycerol oil (i.e., ENOVA brand oil), a low trans oil, a no trans oil, or combinations of any thereof.

In yet an additional embodiment, protein enriched pastas or protein enriched dry mixes may be used in the producing food compositions of the present invention. For instance, soy protein enriched pastas or soy protein enriched dry mixes sold under the brand MIDLAND HARVEST® include at least seven (7) grams of soy protein per serving and are available from Archer Daniels Midland Company of Decatur, Ill.

In one embodiment, the legume product may be produced by milling a legume or legume product into a powder. In another embodiment, a dehydrated legume powder or dehydrated legume flour may be used as the legume powder, and be produced by milling a dehydrated legume or dehydrated legume product into a powder.

In another embodiment, the dehydrated legume or dehydrated legume product is produced using the process described in US Patent Application 2005/0095346 assigned to Archer Daniels Midland Company of Decatur, Ill., entitled Process for the Production of Reconstitutable Bean Products published May 5, 2005, the contents of the entirety of which is incorporated by this reference. In another embodiment, the process for dehydrating the legume or legume product may include blanching the legume or legume product, cooking the blanched legume or legume product, and/or dehydrating the cooked legume or legume product to form a dehydrated or reconstitutable legume or legume product. In a further embodiment, water may be used to blanch and/or cook the legumes or legume products, and an organic acid may optionally be added to the blanching water, the cooking water, or both.

In other embodiments, the process for producing the dehydrated legume or legume products includes conditioning the legumes or legume products by subjecting the legumes or legume products to hydration; cooking the legumes or legume products in a continuous advanced flight pressure vessel; depressurizing the cooked legumes or legume products in a hydrostatic loop; and/or dehydrating the legumes or legume products to form a reconstitutable legume or legume product. In other embodiments, the process for dehydrating the legume or legume product may also include use of an organic acid in the hydration, blanching, and/or cooking step, and the process may further include washing and/or destoning raw legumes used in the process.

In a further embodiment, a dehydrated legume, a dehydrated legume flour, a dehydrated legume powder or a dehydrated legume product used in the foodstuffs of the present invention has an increased dietary fiber percentage on a weight basis as compared to a non-dehydrated or raw legume, flour, powder or product. For example, dehydrated Pinto beans produced with the teachings of US Patent Application 2005/0095346 comprise about 27% dietary fiber, while non-dehydrated or raw Pinto beans comprise about 12% dietary fiber; dehydrated Small Red beans produced with the teachings of US Patent Application 2005/0095346 comprises about 23% dietary fiber, while non-dehydrated or raw Small Red beans comprise about 8.9% dietary fiber; dehydrated Black beans produced with the teachings of US Patent Application 2005/0095346 comprise about 29% dietary fiber, while non-dehydrated or raw Black beans comprise about 13.3% dietary fiber; dehydrated Navy beans produced with the teachings of US Patent Application 2005/0095346 comprise about 23% dietary fiber, while non-dehydrated or raw Navy beans comprise about 9.8% dietary fiber; dehydrated Dark Red Kidney beans produced with the teachings of US Patent Application 2005/0095346 comprise about 24% dietary fiber, while non-dehydrated or raw Light Red Kidney beans comprise about 10.6% dietary fiber; and dehydrated Light Red Kidney beans produced with the teachings of US Patent Application 2005/0095346 comprise about 24% dietary fiber, while non-dehydrated or raw Light Red Kidney beans comprise about 10.6% dietary fiber.

In another embodiment, a dehydrated legume or legume product is subjected to a milling process to produce a dehydrated legume powder. In a further embodiment, the dehydrated legume or legume product is subjected to a form of crushing or pulverizing such as by passage of the dehydrated legume or legume product through a hammer mill or universal mill. In one embodiment, the dehydrated legume or legume product is ground in a PC-20 mill. The ground or powdered dehydrated legume or legume product may be passed through a swecoscreen 60 mesh, wherein the ground or powdered dehydrated legume or legume product has a particle size of less than about 0.250 mm. The ground or powdered dehydrated legume or legume product may further be passed by a magnet to remove any metallic (i.e., iron-containing) contaminants, and further be placed in containers for shipping or placed in a food product.

In other embodiments, various ingredients may be added to the foodstuff in combination with the dehydrated legume products, and other ingredients such as flour or meal. Examples of such various ingredients include, but are not limited to proteins such as wheat protein, wheat protein isolate, wheat gluten, buttermilk solids, milk powders, egg protein, canola protein, pea protein, wheat protein, potato protein, corn protein, sesame protein, sunflower protein, cottonseed protein, copra protein, palm kernel protein, safflower protein, linseed protein, peanut protein, lupin protein, oat protein, soy protein, soy protein concentrates, soy protein isolates and mixtures of any thereof. Other ingredients that may be added to the foodstuff include, but are not limited to, texture modifiers such as, for example, calcium carbonate.

In further embodiments, the foodstuff may be used in combination with other foodstuffs including without limitation, a breakfast cereal, snack bar, a snack chip, nutrition bar, breakfast bar, candy, meat substitute, bread or breading substitute, animal food, puffed snack (i.e., puffed curl, puffed ball, etc. . . . ), crunchy curl, chip, tortilla chip, extruded curl, corn chip, multigrain chip, multigrain snack, flat bread, biscuit, crisp bread, protein inclusion, cone, cookie, flaked product, fortune cookie, pasta, rice cake, puffed wheat cake, maize cake, fruit, vegetable or other known foodstuff.

It yet an additional embodiment, a method for producing instant or quick cook foodstuffs which incorporate reconstitutable whole or intact legume products or powders is disclosed. Snack foods or snack food condiments, which incorporate reconstitutable legume products or powders may also be prepared.

Refried beans are popular as a side dish used in Mexican-style cooking. Mexican-style foods have become one of the fastest growing segments in the American food market, both for home use and in food institutions. Additionally, quick prep soups, meals and side dishes using other various legume and pulse products such as, for example, red beans, navy beans, pinto beans, great northern beans, kidney beans, lima beans, peas and chickpeas are becoming more popular. These legumes are a great source of fiber and have a sugar profile with pro-biotic properties. Further, given today's lifestyles, meals may be prepared quickly, often in 35 minutes or less. When preparing raw, whole legumes, they need to be prepared from scratch in a process that involves several steps. These steps include soaking the beans for several hours or even overnight, cooking the beans in a kettle for several more hours and mashing the cooked beans. The cook usually prepares a large batch, which is then refrigerated and refried by heating a portion of the batch to serve at each meal. Therefore, traditional dry bag beans do not meet the needs of those who prepare meals today.

Further, reconstitutable legume products such as instant or quick prep soups, side dishes, complete meals and snack foods which incorporate legumes and pulse products may also be prepared from dehydrated legume products.

In yet an additional embodiment, the dehydrated legumes, dehydrated legume powders, dehydrated legume flours, or other dehydrated legume product or a food composition including any of these legume products may be produced at a first geographic location and transported or shipped to a second geographic location. For instance, a facility at the first geographic location may be able to produce a product more economically than a facility at the second location due to various factors. The factors may include, inter alia, lower costs of materials (i.e., the legumes themselves, pesticides used for legume production, fertilizers), lower costs of energy (i.e., electricity or gas), lower costs of labor (i.e., wages paid to employees), lower costs of environmental controls or effects (i.e., a drought may be present in one location or certain pesticides may be highly regulated in one location), or any other requirement for production. Further, a certain product may be well suited for production in the first geographic location and desired, but not produced well in the second geographic location. As a non-limiting example, residents of Alaska may desire bananas produced in Central America. Thus, the costs of producing the products in the first geographic location may be less than the costs of producing the products in the second geographic location resulting in the production costs of the product being less in the first geographic location.

In such an instance, the dehydrated legumes, dehydrated legume powders, dehydrated legume flours, other dehydrated legume product or food composition including the dehydrated legume product may be produced at the first geographic location and shipped to the second geographic location such as by transport over water with ships or barges, trucking, flying, or other means of transportation. The geographic location may be a county, a state, a country, a continent and/or combinations of any thereof. In this manner, the product may be produced in a first country, and transported and/or sold in a second country.

Non-limiting examples of food products that may be produced include, but are not limited to, bean dips, taco fillings, taco shells, burrito fillings, tortillas, nacho components, soup bases, soups, taco salad components, side dishes (i.e., refried beans), pasta, tortilla chips, chips, snack foods, milk, juice, soft drinks, other beverages, tortillas, bagels, bread, dough, re-fried beans, salad dressings or any other food product.

The food product may also include an ingredient having a protein such as wheat protein, wheat protein isolate, wheat gluten, buttermilk solids, milk powders, egg protein, canola protein, pea protein, wheat protein, potato protein, corn protein, sesame protein, sunflower protein, cottonseed protein, copra protein, palm kernel protein, safflower protein, linseed protein, peanut protein, lupin protein, oat protein, soy protein, soy protein concentrates, soy protein isolates and mixtures of any thereof. In other embodiments, the food ingredient comprises a flour or a meal. Non-limiting examples of crops that may be used to produce the flour or meal in combination with the de-hydrated legume powder include corn, rice, whole wheat, whole grain, barley, durum, sorghum, sunflower, canola, oats, flax, potatoes, buckwheat and combinations of any thereof (i.e., such as a multigrain product). Other food ingredient that may be used include, without limitation, food colorants, vitamins, minerals, edible oils or fats, emulsifiers, leavening agents, natural or artificial sweeteners, starches, thickening agents, fiber (including, but not limited to, a soluble fiber or an insoluble fiber), a cellulose (i.e., microcrystalline cellulose or carboxymethylcellulose), maltodextrins, corn-syrup solids, potato starch, corn starch, wheat starch, a vegetable product, a fruit product, a nut product or combinations of any thereof may be used.

The invention is further explained by use of the following illustrative EXAMPLES.

### EXAMPLES

### Example I

### Bean and Fruit Salsa

In this embodiment, the following ingredients were mixed together to form particulates of a chunky bean and fruit dip.

TABLE 1

| | | | Grams per |
|---|---|---|---|
| Ingredient | Grams (g) | Percentage (%) | kilogram of dip |
| Dehydrated, | 869.60 | 56.63 | 566.30 |
| whole black | | | |
| beans | | | |
| Dried cherries, | 120.00 | 7.81 | 78.15 |
| chopped | | | |
| Dried apples, | 90.00 | 5.86 | 58.61 |
| chopped | | | |
| Dried pineapple, | 169.20 | 11.02 | 110.19 |
| chopped | | | |
| Celery | 27.67 | 1.80 | 18.02 |
| Scallions | 59.29 | 3.86 | 38.61 |
| Red Bell Peppers | 59.29 | 3.86 | 38.61 |
| Green Bell | 59.29 | 3.86 | 38.61 |
| Peppers | | | |
| Toasted almonds, | 59.29 | 3.86 | 38.61 |
| crushed | | | |
| Cilantro | 10.10 | 0.66 | 6.58 |
| Jalapenos, | 11.86 | 0.77 | 7.72 |
| minced | | | |
| Total | 1535.59 | 100.00 | 1000.00 |

In this embodiment, the following ingredients were mixed together to form a sauce for use with the particulates in the chunky bean and fruit dip. The de-hydrated black bean grits are a de-hydrated black bean product that has been ground to a grit size.

TABLE 2

| Ingredient | Grams (g) | Percentage (%) |
|---|---|---|
| ENOVA ® brand oil, an | 100 | 8.9719 |
| oil comprising mostly | | |
| diacylglycerol oil and that | | |
| is substantially trans fat | | |
| free and available from | | |
| ADM Kao LLC | | |
| NOVAXAN ™ 80 brand | 0.6 | 0.0538 |
| xanthan gum, available | | |
| from Archer Daniels | | |
| Midland Company | | |
| De-hydrated black bean | 100 | 8.9719 |
| grits | | |
| Water | 530 | 47.551 |
| Coconut milk | 300 | 26.916 |
| Cayenne | 0.54 | 0.0484 |
| Black pepper | 0.45 | 0.0404 |
| Cumin | 0.40 | 0.0359 |
| Salt | 6.60 | 0.5921 |
| Lime juice | 25.50 | 2.2878 |
| monoglyceride | 4.00 | 0.3589 |
| Sweet-n-Neat Raisin | 30 | 2.6916 |
| Black bean seasoning | 16.5 | 1.4804 |
| Total | 1114.59 | 100.00 |

The particulates of Table 1 were produced and the sauce of Table 2 was produced. The resulting particulates were admixed with the sauce, thus producing the chunky bean and fruit dip, or salsa. The chunky bean and fruit dip of this example has the following nutritional information per 2 tablespoons (30 grams) serving: 50 calories; 20 fat calories; 2 g of total fat; 0 g of saturated fat; 0 mg of cholesterol; 65 mg of sodium; 6 g of total carbohydrate; 2 g of dietary fiber; 3 g of sugar; and 1 g of protein.

### Example II

### Dip

In this embodiment, the following ingredients were mixed together to form a refried bean dip.

| | | | Grams per |
|---|---|---|---|
| Ingredient | Grams (g) | Percentage (%) | kilogram of dip |
| Water | 440.00 | 61.77 | 617.71 |
| Dehydrated pinto | 88.00 | 12.35 | 123.54 |
| bean grits | | | |
| Dehydrated pinto | 27.00 | 3.79 | 37.90 |
| bean powder | | | |
| Refried bean | 34.00 | 4.77 | 47.70 |
| seasoning mix | | | |
| Ground ginger | 2.00 | 0.28 | 2.81 |
| Sesame flavor | 5.45 | 0.77 | 7.65 |
| Red chili flavor | 0.06 | 0.01 | 0.08 |
| NOVAXAN ™ | 0.80 | 0.11 | 1.12 |
| brand 80 brand | | | |
| xanthan gum | | | |
| Oil | 115.00 | 16.14 | 161.45 |
| Totals | 712.31 | 100.00 | 1000.00 |

The ingredients of the bean dip were mixed as follows. The xanthan gum was dispersed in oil, the water was combined with the bean products and cooked until fully cooked and hydrated, and the seasonings were added to the hydrated, bean products. The xanthan/oil mixture was gradually dispersed in the bean mixture and mixed with shear.

The bean dip of this example has the following nutritional information per 2 tablespoons (30 grams) serving: 60 calories; 45 fat calories; 5 g of total fat; 0 g of saturated fat; 0 mg of cholesterol; 35 mg of sodium; 4 g of total carbohydrate; 2 g of dietary fiber; 0 g of sugar; and 1 g of protein.

### Example III

### Chutney

In this embodiment, the following ingredients were mixed together to form a bean and fruit chutney, or relish.

| | | | Grams per |
|---|---|---|---|
| | | | kilogram of |
| Ingredient | Grams (g) | Percentage (%) | chutney |
| Dehydrated whole | 110.00 | 43.48 | 434.78 |
| beans | | | |
| Dried fruit | 20.00 | 7.91 | 79.05 |
| Celery | 7.00 | 2.77 | 27.67 |
| Scallions | 15.00 | 5.93 | 59.29 |
| Red Peppers | 15.00 | 5.93 | 59.29 |
| Green Peppers | 15.00 | 5.93 | 59.29 |
| Dressing | 28.00 | 11.07 | 110.67 |
| Almonds | 15.00 | 5.93 | 59.29 |
| Parsley | 10.00 | 3.95 | 39.53 |
| Balsamic vinegar | 5.00 | 1.98 | 19.76 |
| Cayenne | 0.15 | 0.06 | 0.59 |
| Liquid smoke | 0.85 | 0.34 | 3.36 |
| Lime juice | 9.00 | 3.56 | 35.57 |
| Jalapenos | 3.00 | 1.19 | 11.86 |
| Totals | 253.00 | 100.00 | 1000.00 |

The chutney of this example has the following nutritional information per 2 tablespoons (30 grams) serving: 70 calories; 45 fat calories; 5 g of total fat; 0 g of saturated fat; 0 mg of cholesterol; 50 mg of sodium; 8 g of total carbohydrate; 3 g of dietary fiber; 0 g of sugar; and 2 g of protein.

### Example IV

### Hummus

In this embodiment, the following ingredients were mixed together to form a black bean hummus.

| | | | Grams per |
|---|---|---|---|
| | | | kilogram of |
| Ingredient | Grams (g) | Percentage (%) | hummus |
| De-hydrated | 100.00 | 20.40 | 203.96 |
| whole black | | | |
| beans | | | |
| Water | 250.00 | 50.99 | 509.89 |
| Fresh lime juice | 28.95 | 5.90 | 59.05 |
| Garlic, mashed | 4.20 | 0.86 | 8.57 |
| Onion, minced | 15.20 | 3.10 | 31.00 |
| Fresh cilantro | 6.10 | 1.24 | 12.44 |
| Yellow bell pepper | 16.00 | 3.26 | 32.63 |
| Cumin | 1.24 | 0.25 | 2.55 |
| Salt | 2.20 | 0.45 | 4.49 |
| Ancho chili paste | 10.40 | 2.12 | 21.21 |
| ENOVA ® brand | 56.00 | 11.42 | 114.22 |
| oil | | | |
| Totals | 490.30 | 100.00 | 1000.00 |

The ancho chili paste was prepared by cleaning, toasting, soaking, pureeing and sieving dried chilies.

The hummus of this example has the following nutritional information per 2 tablespoon (30 grams) serving: 100 calories; 70 fat calories; 7 g of total fat; 0 g of saturated fat; 0 mg of cholesterol; 110 mg of sodium; 8 g of total carbohydrate; 2 g of dietary fiber; 0.5 g of sugar; and 2 g of protein.

### Example V

### Baked Beans

In this embodiment, the following ingredients were mixed together to form a baked bean mix.

| | | Percentage | | |
|---|---|---|---|---|
| Ingredient | Grams (g) | (%) | Dry mix (g) | Dry mix (%) |
| Water | 425.00 | 68.44 | 0 | 0 |
| De-hydrated | 40.00 | 6.44 | 41.20 | 18.73 |
| whole Great | | | | |
| Northern | | | | |
| beans | | | | |
| De-hydrated | 40.00 | 6.44 | 41.20 | 18.73 |
| whole Navy | | | | |
| beans | | | | |
| Baked bean | 36.00 | 5.80 | 58.00 | 26.36 |
| seasoning | | | | |
| De-hydrated | 20.00 | 3.22 | 22.00 | 10.00 |
| whole Myasi | | | | |
| beans | | | | |
| Dry mustard | 20.00 | 3.22 | 1.20 | 0.55 |
| flavor | | | | |
| Silva spray- | 20.00 | 3.22 | 20.00 | 9.09 |
| dried tomato | | | | |
| powder | | | | |
| Molasses (in | 20.00 | 3.22 | 15.50 | 7.05 |
| dry product, | | | | |
| Sweet-n-Neat | | | | |
| 4000) | | | | |
| Maltodextrin | 0 | 0 | 15.00 | 6.82 |
| 10DE | | | | |
| Air dried | 0 | 0 | 2.00 | 0.91 |
| celery | | | | |
| Air dried | 0 | 0 | 1.50 | 0.68 |
| green | | | | |
| peppers | | | | |
| Air dried red | 0 | 0 | 1.10 | 0.50 |
| peppers | | | | |
| Air dried leeks | 0 | 0 | 1.30 | 0.59 |
| Totals | 621.00 | 100.00 | 220.00 | 100.00 |

In this embodiment, the ingredients of the dry mix may be mixed together, and prepared into a food product by hydration with water and heating. In another embodiment, the dry mix ingredients may be placed or packaged into a container associated with indicia directing a user how to hydrate the product into the baked bean mix. The dry mix in the container may also be shipped or transported from one location to another location, wherein shipping of the dry mix is more economical than shipping the mix containing water since the water may be added to the dry mix instead of being transported.

### Example VI

### Soup

In this embodiment, the following ingredients were mixed together to form a Mexican broth soup mix.

| Ingredient | Grams (g) | Percentage (%) |
|---|---|---|
| Water (or vegetable | 682.00 | 66.3 |
| broth) | | |
| 1 box of MIDLAND | 113.00 | 11.0 |
| HARVEST ® brand Chili | | |
| mix available from | | |
| Archer Daniels Midland | | |
| Company | | |
| De-hydrated whole red | 50.00 | 4.9 |
| kidney beans | | |
| De-hydrated whole black | 25.00 | 2.4 |
| beans | | |
| Savory vegetable flavor, | 2.50 | 0.2 |
| available from ConAgra | | |
| Air-dried green pepper | 5.25 | 0.5 |
| strips available from Van | | |
| Drunen Farms | | |
| Air-dried red pepper | 4.40 | 0.4 |
| strips available from Van | | |
| Drunen Farms | | |
| Air-dried celery, cross- | 9.80 | 0.1 |
| cut available from Van | | |
| Drunen Farms | | |
| Air-dried leeks available | 4.00 | 0.4 |
| from Van Drunen Farms | | |
| Air-dried cross-cut | 7.30 | 0.7 |
| carrots available from | | |
| Van Drunen Farms | | |
| Air-dried corn available | 7.90 | 0.8 |
| from Van Drunen Farms | | |
| Air-dried ⅜″ tomatoes | 5.80 | 0.6 |
| available from Van | | |
| Drunen Farms | | |
| Chicken flavor available | 0.40 | ~0.01 |
| from T. Hasegawa | | |
| Beef flavor available | 0.55 | ~0.01 |
| from T. Hasegawa | | |
| MIDLAND HARVEST ® | 86.00 | 8.4 |
| brand elbow macaroni | | |
| available from Archer | | |
| Daniels Midland | | |
| Company | | |
| Chipotle Pepper powder | 0.60 | ~0.01 |
| Salt | 2.00 | 0.2 |
| Silva tomato powder | 11.00 | 1.1 |
| Chili powder | 4.00 | 0.4 |
| Cumin | 1.50 | 0.1 |
| Vegetarian beef flavor | 4.00 | 0.4 |
| Lime peel available from | 1.50 | 0.1 |
| Van Drunen Farms | | |
| Total | 1028.50 | ~100 |

The soup was prepared by bringing the water to a boil, adding the ingredients to the boiling water, and simmering for 10-12 minutes or until the pasta and beans are tender. Salt and pepper may be added to taste, and cilantro may also be used. This embodiment produces about 5 one cup servings and may be adjusted to produce larger quantities.

In another embodiment, the ingredients may be mixed together without the liquid, and prepared into a food product by hydration of the mixed dry ingredients with water and, optionally, heating. The dry mix ingredients may also be placed or packaged into a container associated with indicia directing a user how to prepare the product into the finished Mexican broth soup. The dry mix in the container may also be shipped or transported from one location to another location, wherein shipping of the dry mix is more economical than shipping the mix containing water since the water may be added to the dry mix instead of being transported.

### Example VII

### Bean Soup

In this embodiment, the following ingredients were mixed together to form a hearty bean soup including soy powder.

| Ingredients | Grams (g) | Percentage (%) |
|---|---|---|
| Water | 7250 | 42.9 |
| NUTRISOY ® brand whole | 252 | 1.5 |
| soybean powder | | |
| Carrots, large diced | 300 | 1.8 |
| Onions, large diced | 500 | 3.0 |
| Celery, large diced | 300 | 1.8 |
| Dried whole thyme | 50 | 0.3 |
| 3 bay leaves | ~1 | ~0.01 |
| Instant, seasoned refried | 2200 | 13.1 |
| beans, dry | | |
| Dehydrated whole beans | 550 | 3.3 |
| Carrots, small diced | 800 | 4.7 |
| Celery, small diced | 800 | 4.7 |
| Onions, small diced | 200 | 1.2 |
| Red and Green peppers, | 1000 | 6.0 |
| small diced | | |
| Cooked, MIDLAND | 1200 | 7.1 |
| HARVEST ® brand elbow | | |
| macaroni | | |
| HME (high moisture | 1500 | 8.9 |
| extrusion) chicken | | |
| analogue | | |
| Total | 16903 | ~100.0 |

The NUTRISOY® brand whole soybean powder was mixed in water until completely dissolved. The large, diced vegetables, thyme and bay leaves were added to the water mixture and brought to a boil and simmered for thirty minutes. The cooked liquid was strained, and the cooked vegetables were discarded. The remaining liquid was brought to a gentle boil, the refried beans were added and mixed. The small, diced vegetables were added and allowed to simmer for five minutes. The cooked macaroni and HME chicken analogue were added and allowed to simmer for three minutes, or until hot. Salt and pepper were added to taste.

In another embodiment, the ingredients may be mixed together without the liquid, and prepared into a food product by hydration of the mixed dry ingredients with water and, optionally, heating. The dry mix ingredients may also be placed or packaged into a container associated with indicia directing a user how to prepare the product into the finished hearty bean soup including soy powder. The dry mix in the container may also be shipped or transported from one location to another location, wherein shipping of the dry mix is more economical than shipping the mix containing water since the water may be added to the dry mix instead of being transported.

### Example VIII

### Bean Soup

In this embodiment, the following ingredients were mixed together to form a hearty bean soup dry including soy powder.

| Ingredient | Grams (g) | Percentage (%) |
|---|---|---|
| MIDLAND HARVEST ® | 250 | 5.3 |
| brand elbow macaroni | | |
| Water | 3500 | 74.5 |
| De-hydrated whole | 163 | 3.5 |
| beans | | |
| NUTRISOY ® brand | 60 | 1.3 |
| whole soybean powder | | |
| Carrots, air-dried ⅜″ | 20 | 0.4 |
| Celery, air-dried, cross- | 15 | 0.3 |
| cut | | |
| Onions, air-dried | 11 | 0.2 |
| Red and green peppers, | 23 | 0.5 |
| ⅜″ | | |
| MIDLAND HARVEST ® | 172 | 3.7 |
| brand recipe strips, a | | |
| chicken-like strip | | |
| Silva tomato powder | 20 | 0.4 |
| Savory vegetable flavor | 6.5 | 0.1 |
| Salt | 6.0 | 0.1 |
| Garlic powder | 3.5 | ~0.01 |
| Dried whole thyme | 0.35 | ~0.01 |
| Black pepper, 25 mesh | 1.0 | ~0.01 |
| Dried whole rosemary | 0.2 | ~0.01 |
| Dispersible xanthan gum | 4.5 | ~0.01 |
| Instant, seasoned, dehydrated | 350 | 7.4 |
| refried beans, | | |
| dry | | |
| Total | 4700 | ~100 |

The water was brought to a boil, and all of the ingredients, except the refried beans, were added to the boiling water and cooked for about 12 minutes until completion. The refried beans were added and mixed. The mixture was allowed to set for about 5 minutes and mixed. The mixture may be adjusted for desired consistency with additional water. The seasoning was adjusted to taste with salt and pepper.

In another embodiment, the ingredients may be mixed together without the liquid, and prepared into a food product by hydration of the mixed dry ingredients with water and, optionally, heating. The dry mix ingredients may also be placed or packaged into a container associated with indicia directing a user how to prepare the product into the finished hearty bean soup dry including soy powder. The dry mix in the container may also be shipped or transported from one location to another location, wherein shipping of the dry mix is more economical than shipping the mix containing water since the water may be added to the dry mix instead of being transported.

The present invention has been described with reference to certain exemplary embodiments, legume products, compositions and uses thereof. However, it will be recognized by those of ordinary skill in the art that various substitutions, modifications or combinations of any of the exemplary embodiments may be made without departing from the spirit and scope of the invention. Thus, the invention is not limited by the description of the exemplary embodiment, but rather by the appended claims as originally filed.

What is claimed is:

1. A composition comprising:
a legume ingredient having an increased dietary fiber content as compared to a legume from which the legume ingredient originates on a dry weight basis, the legume ingredient being selected from the group consisting of a substantially intact dehydrated legume, a dehydrated legume grit, a dehydrated legume powder and a combination of any thereof;
a compound selected from the group consisting of a diacylglycerol oil, xanthan gum, whole soybean powder, a soluble fiber, an emulsifier, a protein enriched pasta, a protein enriched dry mix, and combinations of any thereof; and
water present in an amount such that the composition has the characteristics of a foodstuff selected from the group consisting of a dip, a sauce, a chutney, hummus, a dressing, a baked bean mix, a soup, a jam, a jelly, a salsa, a picante, an enchilada sauce, a taco sauce, a burrito sauce, a marinade, a condiment, a stew, a chowder, a pasta sauce and a tomato based sauce;
the composition having at least two grams of dietary fiber per thirty grams of the composition.

2. The composition of claim 1, further comprising an ingredient selected from the group consisting of a fat, an oil, a thickening agent, a sweetener, a dehydrated legume flour, a maltodextrin, soy concentrate, soy isolate, canola protein, whey protein, wheat protein, a second substantially intact dehydrated legume, a fruit product, a nut product, a vegetable product, a spice, a seasoning, a tomato product, a calcium containing compound, and combinations of any thereof.

3. The composition of any one of claims 1, wherein the legume from which the legume ingredient originates from is a bean or a pea.

4. The composition of any one of claims 1, wherein the legume ingredient is produced by a process comprising:
blanching a legume or legume product;
cooking the blanched legume or the blanched legume product; and
dehydrating the cooked legume or the cooked legume product.

5. The composition of any one of claims 1, wherein the legume from which the legume ingredient originates is selected from the group consisting of yellow peas, green peas, lentils, chickpeas, peanuts, trefoil, pinto beans, great northern beans, navy beans, red beans, black beans, dark or light red kidney beans, fava beans, green baby lima beans, pink beans, MYASI beans, mayocoba beans, small red beans, black eyed beans, garbanzo beans, cranberry beans, white beans, rice beans, butter beans, African giraffe beans, and combinations of any thereof.

6. The composition of any one of claims 1, further comprising an ingredient selected from the group consisting of a colorant, a vitamin, a mineral, a leavening agent, a starch, a digestion resistant starch, an insoluble fiber, a cellulose, a maltodextrin, a corn-syrup solid, a sterol, a lignan, an organic acid, a sugar alcohol and any combination thereof.

7. The composition of any one of claims 1, wherein the composition comprises at least 1 gram of protein per the 30 grams of the composition.

8. The composition of claim 1, the composition being configured as a food dip, further comprising at least one of a fruit product, a vegetable product and combinations thereof.

9. The composition of claim 1, the composition being configured as a sauce or a dressing, further comprising an edible fat or oil.

10. The composition of claim 9, wherein:
the edible fat or oil comprises a substantially trans fat free oil;
the thickening agent comprises xanthan gum; and
the emulsifier comprises a monoglyceride.

11. The composition of claim 1, the composition being configured as a salsa, comprising:
an edible fat or oil;
a thickening agent; and
at least one of a fruit product, a vegetable product and combinations thereof.

12. The composition of claim 11, wherein:
the edible fat or oil comprises a substantially trans fat free oil;
the thickening agent comprises xanthan gum; and
the emulsifier comprises a monoglyceride.

13. The composition of claim 1, the composition being configured as a food dip, further comprising a thickening agent.

14. The composition of claim 1, the composition being configured as hummus, further comprising:
at least one of a fruit product, a vegetable product, and combinations thereof; and
an edible fat or oil.

15. The composition of claim 1, the composition being configured as a baked bean mix, further comprising:
at least one seasoning; and
at least one of a fruit product, a vegetable product, and combinations thereof.

16. The composition of claim 15, further comprising:
a maltodextrin; and
the legume ingredient comprising whole beans selected from the group consisting of great northern beans, navy beans, myasi beans, pinto beans, and combinations of any thereof.

17. The composition of claim 1, the composition being configured as a soup, comprising:
at least one of a fruit product, a vegetable product, and combinations thereof; and
a soy protein source.

18. The composition of claim 17, wherein the soy protein source is selected from the group consisting of a soy powder, a soy concentrate, a soy isolate and combinations of any thereof.

19. A method of increasing fiber and/or protein consumption in a population, the method comprising distributing the composition of claim 1 to the population.

20. The composition of claim 3, wherein the oil is selected from the group consisting of interesterified oil having zero grams of trans-fat per serving, sunflower oil, canola oil, soy oil, peanut oil, cotton seed oil, palm oil, a low trans oil, a no trans oil and combinations of any thereof.
